(19) United States
(12) Patent Application Publication
(10) Pub. No.: US 2004/0015371 A1
(43) Pub. Date: Jan. 22, 2004

(54) System and method for managing job applicant data

(76) Inventors: Zachary Thomas, Merion Station, PA (US); Shawn Sterling, Martell, NE (US); SaiPrasad Kapila, King of Prussia, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/621,267

(22) Filed: Jul. 16, 2003

Related U.S. Application Data
(60) Provisional application No. 60/396,341, filed on Jul. 16, 2002.

(51) Int. Cl. G06F 17/60

(52) U.S. Cl. 705/1

(57) ABSTRACT

A method and system of managing recruitment data provides an online application process that prohibits submission of a job application unless the applicant selects one or more available jobs. The applicant is also required to submit gender and ethnicity information. The applicant's information is stored in a database where it is related to jobs or job groups so that the employer can create a profile of the gender, ethnicity, and optionally other applicant data for applicants who apply for specified jobs or job groups. Preferably, the system also allows the employer to track similar information for new hires and thus profile an applicant pool and compare it to a profile of actual hires.

### FIELD OF THE INVENTION

This invention relates generally to methods and systems for managing applicant data for job positions. More particularly, the present invention is related to a method and system which allows applicants to apply for a specific job opening and helps employers manage job applicant information and track relationships between job applicant attributes, new hire attributes, and jobs or job groups.

### BACKGROUND OF THE INVENTION

The process of receiving and organizing job applications requires a considerable expenditure of time, effort and resources for employers. Unsolicited applications for jobs for which there are no open positions are usually mixed in with other applications, and they must each be sorted through individually, usually by human resources personnel, in order for the employer to solicit relevant information from the applicant, respond to the applicant, and comply with third party and/or government reporting obligations. One feature that application processes, including automated processes, have lacked is a method of limiting the application flow to only specific, open positions, thereby limiting the employer's application flow to those seeking available positions. If a method and system were available which required applicants to apply only for specific job positions, or job groups, employer time which is wasted by sorting through applications which have no possibility for employment could be greatly reduced. Furthermore, by requiring an applicant to limit his or her application to only specific openings of interest, an employer is more likely to receive applications with qualifications which correlate to those required by the open position.

Existing procedures for accepting job applications do not include a reliable and consistent method for soliciting and tracking information from applicants and new hires which can be easily generated into reports, particularly reports which are compliant with guidelines and standards imposed on the employer by third parties, such as the government. For example, the reporting and data gathering guidelines of the Office of Federal Contractor Compliance (OFCCP) and the Department of Labor (DOL) as set forth in Executive Order 11246 (EO 11246) and amended by Executive Order 11375 (EO 11375), require federal contractors to provide detailed reports on applicant and employee gender and ethnicity information.

EO 11246, which prohibits federal contractors from discriminating in employment on the basis of religion, race, color, sex or national origin, requires certain federal contractors to maintain a written affirmative action plan to implement and monitor efforts to employ women and minorities. This required affirmative action plan includes a requirement that the contractor/employer provide an “organizational profile” report, which is essentially a depiction of staffing patterns within the organization. In this report, jobs with similar content, wage rates and opportunities must be combined into specific job groups. Without a system and method which automatically links each job opening to a specific job group, it is difficult for organizations to efficiently and systematically generate reports which comply with such requirements.

The required affirmative action plan also includes a requirement that the federal contractor provide an “availability analysis” report. This report provides information on the percentage of all qualified minorities or women out of all of the applicants available to work in a job group. Since most application processes do not have a method of limiting the applicants to a specific job group, unsolicited applications, or applications which are not for a specific job, have to be considered applicants for all positions, thereby distorting the percentage calculations performed for the availability analysis report. Furthermore; most employers have no way of requiring an applicant to submit gender and ethnicity information, making such analysis reports difficult to generate. Thus, a method and system which requires an applicant to specify a particular job and to specify gender and ethnicity information in order to complete and submit an application would facilitate accurate reporting.

It is also difficult for employers to generate reports which organize applicant information by category. If all information submitted by an applicant were organized on a central database, reports could be easily generated according to any category. When an applicant is hired, the applicant's information, which would already be stored in the database, could be changed to reflect his/her employment status. Without a central database which maintains the information submitted by applicants, and without requiring fundamental information from an applicant in order for the information to be stored in the database, it is difficult for employers to generate accurate reports for both hired employees and applicants, to accurately perform statistical analyses on its applicants and employees, and to generate reports reflecting desired information retained on each applicant and employee, such as job group, gender, and ethnicity.

The present invention is directed to solving one or more of the problems listed above.

### SUMMARY OF THE INVENTION

In accordance with a first embodiment of the invention, a method of managing job applicant data includes the steps of (1) receiving an applicant request for a specified job; (2) receiving applicant data; (3) storing the applicant data in a database; (4) linking one or more elements of the applicant data to an employer position; and (5) providing a report profile whereby a resulting report relates one or more elements of the applicant data for a plurality of applicants to one or more of the employer positions. Optionally, the elements of the applicant data comprise data indicative of gender and ethnicity. Further, each employer position may comprise a specified job or a job group that corresponds to one or more specified jobs.

Optionally, the method also includes the steps of storing new hire data in the database and linking one or more elements of the new hire data to an employer position. The report resulting from the report profile further relates one or more elements of the new hire data for a plurality of new hires to one or more of the employer positions. Preferably, the elements of the new hire data comprise data indicative of gender and ethnicity.

Preferably, an applicant request will be rejected unless at least one job is specified.

The method may also include the step of displaying a list of available specified jobs prior to the first receiving step. It may also include the step of providing a search engine whereby a user may search for available jobs prior to the first receiving step. Also, it may include the step of providing a jobs agent that periodically searches a database of available jobs and notifies a user when a job meeting user-specified criteria is available.

In accordance with an alternate embodiment, any or all of the above steps may be implemented by a recruitment data management system that includes an employer computing device that includes a memory and a processor, as well as an employer database that is accessible by the employer computing device. The memory stores computer program instructions that can instruct the employer computing device to perform any or all of the steps.

In accordance with a third embodiment, a recruitment data management system comprises: (1) a means for receiving an applicant request for a specified job and prohibiting receipt of a request unless a job is specified; (2) a means for receiving and storing applicant data that includes gender and ethnicity information; and (3) a means for providing a report that relates one or more elements of the applicant data for a plurality of applicants to one or more of the employer positions.

In accordance with a fourth embodiment, a method of managing job applicant data comprises the steps of (1) receiving an applicant request for a specified job and prohibiting receipt of a request unless a job is specified; (2) receiving applicant data including gender and ethnicity information; (3) storing the applicant data in a database; (4) linking one or more elements of the applicant data to the specified job or a job group; and (5) providing a report profile whereby a resulting report relates one or more elements of the applicant data for a plurality of applicants to one or more specified jobs or job groups. Preferably, the method also includes the steps of: (6) storing, in the database, new hire data comprising gender and ethnicity information; and (7) linking one or more elements of the new hire data to one of the specified jobs or job groups. In this case, the report resulting from the report profile further relates one or more elements of the new hire data for a plurality of new hires to one or more of the specified jobs or job groups.

### BRIEF DESCRIPTION OF THE DRAWINGS

FIG. 1 illustrates a preferred relationship between an employer's computer and one or more job applicant computers.

FIG. 2 is an exemplary computer screen shot showing examples of the types of categories on which an applicant may search in accordance with a preferred embodiment.

FIG. 3 is an exemplary computer screen shot showing the types of information that an employer may request in an employer report in accordance with a preferred embodiment.

FIG. 4 is a process flow diagram showing preferred elements of a job candidate application process.

FIG. 5 illustrates an exemplary computer of a type suitable for carrying out and/or comprising the system of the invention.

FIG. 6 illustrates a block diagram of the internal hardware of the computer of FIG. 5.

### DETAILED DESCRIPTION OF THE INVENTION

The present invention provides a method and system for receiving data for job positions that assists employers in their definition and limitation of applicant flow and helps manage job applicant information and track relationships between job applicant attributes, new hire attributes, and jobs or job groups.

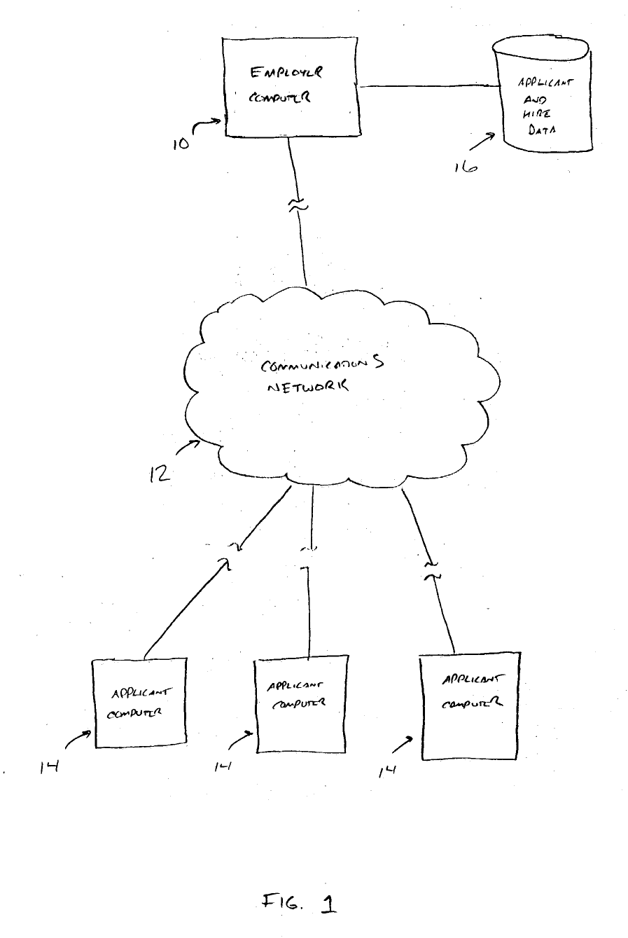

In accordance with a preferred embodiment of the present invention, FIG. 1 illustrates a system relating one or more job applicant computers to an employer's computer or computers. Referring to FIG. 1, an employer computer 10 is equipped with a processor, a memory, operating system software, and communications software such as an Internet browser, and it is connected to a communications network 12. The communications network 12 is preferably the Internet, but it may also be a local area network (LAN), wide area network (WAN), public switched transfer network (PSTN), or any other type of communications network through which computers can exchange data. Optionally, the employer computer 10 may be connected to a LAN, WAN, or other network, which in turn is connected to an external communications network such as the Internet. As used herein references to an employer computer 10 or employer's computer memory can include not only those actually operated by an employer, but also those operated by a third party service provider on behalf of an employer. Similarly, the term “employer” can also include an agent or service provider of the employer.

Job candidates or representatives of job applicants may access the communications network 12 through one or more other computers 14, which also contain a processor, a memory, operating system software, and communications software such as an Internet browser.

The employer computer 10 memory stores computer program instructions that instruct the computer to prompt the candidate as the candidate walks through a preferred embodiment of the job application process. Optionally, the instructions may be downloaded to the job applicant's computer 14, such as through an application or applet, or the instructions may be stored on another memory that is in communication with both the employer computer 10 and the applicant's computer 14.

The application process requires that the candidate or candidate's representative apply only for one or more specific open positions, thereby limiting the employer's application flow to those seeking available positions. Additionally, the process can only be completed and the application submitted to the employer if the candidate enters mandatory profile information, such as gender and ethnicity, which preferably includes an option for the candidate to elect not to answer. Thus, the employer can link profile information to jobs or job categories. Also, by limiting the position selection option, the employer may preclude itself from receiving unsolicited resumes for “any available position”, thus allowing the employer to limit hiring decisions to those applicants who express an affirmative interest in a particular position. Optionally, although not preferably, the employer may provide an “all positions” selection option.

The employer computer 10 can access an employer database 16 (which optionally could be operated by a third party service provider) that includes a table or other data structure that stores data relating to jobs and/or job groups, job applicants, one or more attributes of job applicants, and one or more attributes of new hires. The employer database 16 may be contained in the same memory containing the program instructions, or the employer database 16 may be maintained on a separate memory within the employer computer 10 or on a separate computer that is connected to the employer computer 10 either by direct connection or through a communications medium.

Optionally, as an alternative to the embodiment shown in FIG. 1, instead of having a separate applicant computer, the job applicant may enter the information directly onto an employer computer 10, such as at a computer terminal located in an employer's lobby or human resources department, or an employer representative may enter the applicant information into an employer computer 10 based on information received from the applicant.

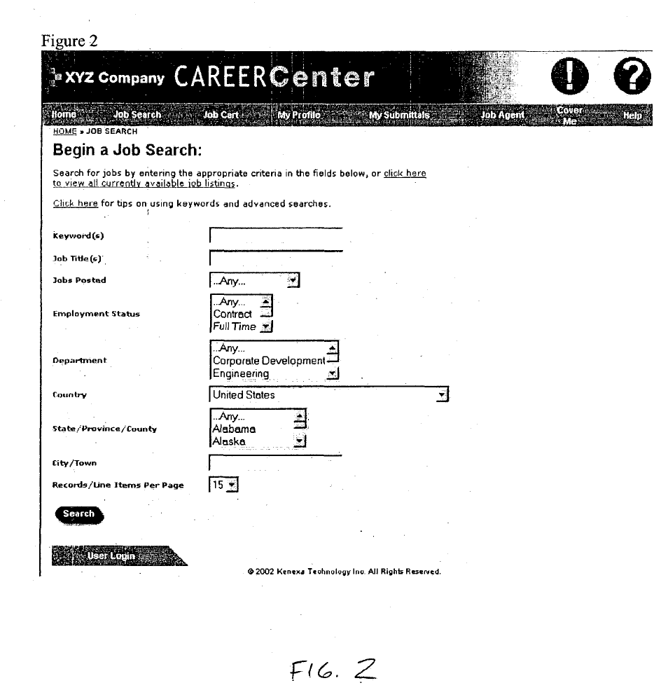

Preferably, the method and system allows a candidate to search the employer database 16 for available job positions before beginning the application process. FIG. 2 shows examples of the types of categories on which an applicant may search in accordance with a preferred embodiment. Referring to FIG. 2, the categories may include, for example, posting date, job title, department, geographic location, and/or status (such as full time or part time). Alternatively and/or additionally, however, the candidate may be presented with a list of available positions. The positions are grouped into employer-defined categories for easy searching and data management, such as job group, department and job title.

The employer database 16 also contains a table or other data structure that stores job candidate profile information as received from job applicants and new hire information as entered by or on behalf of the employer. When a candidate submits a complete application, the candidate's profile information is saved into the memory of the employer computer 10. The information is saved to the employer database 16 in employer defined categories for easy searching, such as by education, salary expectations, and/or geographic preference.

The candidate's profile information includes applicant gender and ethnicity information, preferably stored in another table or data structure within the employer database 16 in a location separate from the candidate's profile information. When the applicant submits a complete application, the candidate's gender and ethnicity information is saved into the employer database 16. The information is saved, preferably to a table, in employer defined categories for easy searching, such as gender, ethnicity, prefer not to disclose, and/or job group.

When a candidate is hired, the employer is preferably allowed to change the applicant's designation in the database to a “hire”, or the employer may enter a new entry that also designates the applicant as an employee. Thus, the employer can track the attributes (such as gender and/or ethnicity) of applicants for job positions and the attributes of those actually hired for such positions for later reporting that compares the attributes of applicant pools to the attributes of actual hires.

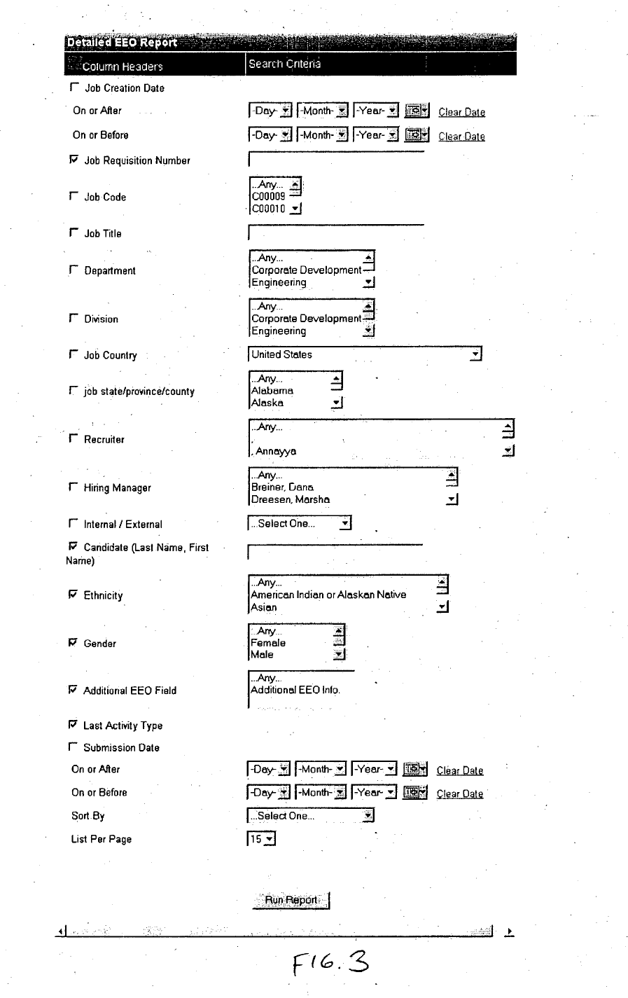

The method and system allow the employer to search the employer database 16 for specific candidate profile information and/or gender and ethnicity information and request a report. The computer program instructs the employer computer 10 to prompt the employer to choose certain variables for searching the employer database 16 within the employer defined categories. For example, the employer may request a report according to employment type (e.g. full-time, hourly, internship, contract), job group, gender, and/or ethnicity. A screen shot showing examples of the types of information that an employer may select in a report in a preferred embodiment is shown in FIG. 3. The results of the search can be used to generate reports which are compliant with third party and/or government standards, such as the applicant reporting and data gathering guidelines of the Office of Federal Contractor Compliance (OFCCP) and the Department of Labor (DOL) as set forth in Executive Order 11246 and amended by Executive Order 11375. For example, the various job positions may be tied to a specific group, such as management, clerical, technical, or other groups. The report may show the gender, ethnicity, and/or other attributes of the applicants for the applicant group, such as by percentages or ratios. The report may also show similar attributes for actual hire, thus allowing the employer to determine whether the gender and/or ethnicity of actual hires reflect those of an applicant pool. Optionally, other variables, such as geographic location, employment status (full time or part time) and/or job posting date may also be factored into the report in order to allow the employer to track variations in applicant pools and hires that may result from such variables.

Preferably, the reports are formatted to have export functionality with a commonly-used spreadsheet program such as Microsoft Excel, or another program such as a word processor or database. Also, the system can preferably interface with enterprise resource planning (ERP) software such as PeopleSoft, SAP, Oracle, or other ERP software.

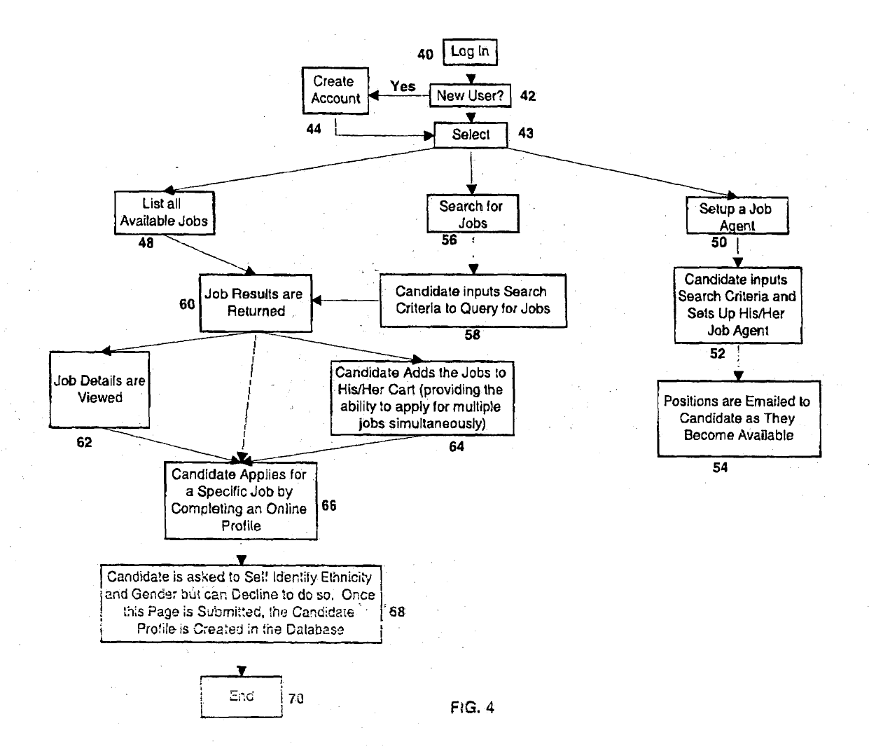

In a preferred embodiment, the program instructions instruct a computer to prompt the candidate to walk through the job application process in accordance with steps such as those illustrated in FIG. 4. Referring to FIG. 4, the candidate reaches the employer's website or other input means 40, and the candidate preferably is prompted to log in as a return user or to proceed as a new user 42. If the candidate opts to proceed as a new user, the computer program instructs the computer to prompt the candidate for employer defined information 44, such as name and address. Optionally, the candidate may choose to enter as a return user and submit new contact information. The candidate then begins the application process by selecting 43 an option, such as listing all available jobs 48, searching the available jobs database 56, and/or electing to setup a “job agent” 50 which allows a candidate to submit a request for e-mail notification of desired job openings when they become available.

If the candidate elects to setup a job agent 50, the system prompts the candidate to enter specific search criteria 52 from within employer defined categories of the employer's database, desired frequency of notification, and contact information. For example, the candidate may request notification of openings of a particular job title, job department, or job group. The candidate inputs the required criteria and contact information. The computer then stores the search criteria with the candidate's contact information in the employer database 16, and notifications 54, such as e-mail notifications, are sent to the candidate on a periodic basis. For example, the computer may send e-mail notifications of job openings of certain job titles within a particular job department at a period of time specified by the candidate, such as once every month. Preferably, the notifications also include a link that directs the candidate to the application process. Additionally, the notifications preferably include the option of allowing the candidate to discontinue receiving the e-mails by including an “unsubscribe” prompt. When the candidate finishes entering all of the required information for the job agent, the candidate has the option of proceeding with the job application process.

Going back to the selection option 43, if the candidate elects to search for jobs 56, the computer prompts the candidate to input search criteria for desired job listings 58. For example, the candidate may opt to search by job title, department, geographic area, or employment status (e.g., full time, part time). The candidate may also have the option of choosing a list of all available jobs 48 instead of searching the employer database 16. Once the candidate submits either a search or a request for all available job listings, the computer produces a list of results 60. The candidate then has the option of linking to each individual job for a detailed description provided by the employer 62, or selecting a specific job 64 and proceeding with the application process. Importantly, the applicant is not permitted to proceed with the application process unless a specific job is selected, thus allowing the employer to link applicant profile information with specific jobs or job groups.

When the candidate has proceeded to the job application process for a specific job, if profile information is not already in the database, the system prompts the candidate to complete an applicant profile 66. The applicant profile requests the candidate to submit employer defined information. For example, the applicant may be requested to submit information on his/her education, salary expectations, and/or geographic preference. Optionally, the candidate may be prompted to submit a resume electronically, create a resume while connected to the communications network, or cut and paste a resume into the profile screen to be submitted with the applicant's profile information. The process may also optionally direct the candidate to one or more recruiting questionnaires requiring specific information from the candidate.

After the candidate has submitted the applicant profile, the computer program instructs the computer to prompt the candidate to enter Equal Opportunity Employer (EEO) information. For example, the candidate is preferably prompted to submit gender and ethnicity information 68. The applicant's response may be a choice to not provide such information, but preferably the applicant must make some response to the question. If the candidate does not complete this information, the computer preferably displays a warning that the candidate's application will not be submitted if this information is not entered, and the candidate is prompted again to submit the EEO information. Once the information is submitted, the application is complete and the candidate's profile information is saved to the employer's database. Optionally and preferably, the applicant may leave the application process at any time, but the applicant's profile and EEO information is not saved until the application process is completed.

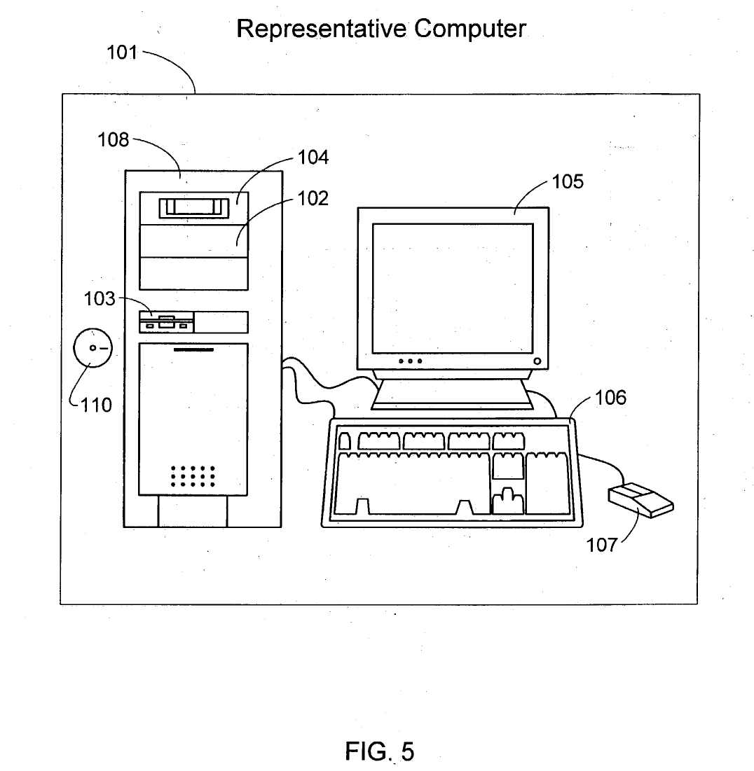

FIG. 5 illustrates an exemplary computer of a type suitable for carrying out and/or comprising the system elements of the invention. Viewed externally in FIG. 5, a computer system designated by reference numeral 101 has a central processing unit located within a housing 108 and disk drives 103 and 104. Disk drives 103 and 104 are merely symbolic of a number of disk drives which might be accommodated by the computer system. Typically these would include a hard disk drive and optionally one or more floppy disk drives such as 103 and/or one or more CD-ROMs, CD-Rs, CD-RWs or digital video disk (DVD) devices indicated by slot 104. The number and types of drives typically varies with different computer configurations. Disk drives 103 and 104 are in fact options, and they may be omitted from the computer system used in connection with the processes described herein. Additionally, the computer system utilized for implementing the present invention may be a stand-alone computer having communications capability, a computer connected to a network or able to communicate via a network, a handheld computing device, or any other form of computing device capable of carrying out equivalent operations.

The computer also has or is connected to or delivers signals to a display 105 upon which graphical, video and/or alphanumeric information is displayed. The display may be any device capable of presenting visual images, such as a television screen, a computer monitor, a projection device, a handheld or other microelectronic device having video display capabilities, or even a device such as a headset or helmet worn by the user to present visual images to the user's eyes. The computer may also have or be connected to other means of obtaining signals to be processed. Such means of obtaining these signals may include any device capable of receiving images and image streams, such as video input and graphics cards, digital signal processing units, appropriately configured network connections, or any other microelectronic device having such input capabilities.

An optional keyboard 106 and a directing device 107 such as a remote control, mouse, joystick, touch pad, track ball, steering wheel, remote control or any other type of pointing or directing device may be provided as input devices to interface with the central processing unit.

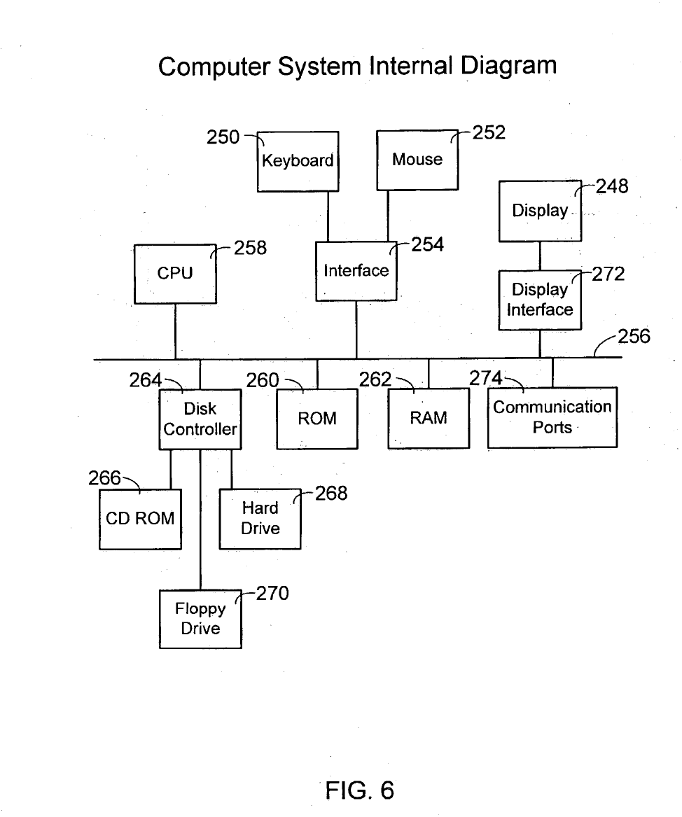

FIG. 6 illustrates a block diagram of the internal hardware of the computer of FIG. 5. A bus 256 serves as the main information highway interconnecting the other components of the computer. CPU 258 is the central processing unit of the system, performing calculations and logic operations required to execute a program. Read only memory (ROM) 260 and random access memory (RAM) 262 constitute the main memory of the computer.

A disk controller 264 interfaces one or more disk drives to the system bus 256. These disk drives may be external or internal floppy disk drives such as 270, external or internal CD-ROM, CD-R, CD-RW or DVD drives such as 266, or external or internal hard drives 268. As indicated previously, these various disk drives and disk controllers are optional devices.

Program instructions may be stored in the ROM 260 and/or the RAM 262. Optionally, program instructions may be stored on a computer readable carrier such as a floppy disk or a digital disk or other recording medium 110, a communications signal, or a carrier wave.

Returning to FIG. 6, a display interface 272 permits information from the bus 256 to be displayed on the display 248 in audio, graphic or alphanumeric format. Communication with external devices may optionally occur using various communication ports such as 274.

In addition to the standard components of the computer, the computer also includes an interface 254 which allows for data input through the keyboard 250 or other input device and/or the directional or pointing device 252 such as a remote control, pointer, mouse or joystick.

It is to be understood that the invention is not limited in its application to the details of construction and to the arrangements of the components set forth herein or illustrated in the drawings. The invention is capable of other embodiments and of being practiced and carried out in various ways. Also, it is to be understood that the phraseology and terminology employed herein are for the purpose of description and should not be regarded as limiting.

The invention claimed is:

1. A method of managing job applicant data, comprising:
receiving an applicant request for a specified job;
receiving applicant data;
storing the applicant data in a database;
linking one or more elements of the applicant data to an employer position; and
providing a report profile whereby a resulting report relates one or more elements of the applicant data for a plurality of applicants to one or more of the employer positions.

2. The method of claim 1 wherein the elements of the applicant data comprise data indicative of gender and ethnicity.

3. The method of claim 1 wherein each employer position comprises a specified job or a job group that corresponds to one or more specified jobs.

4. The method of claim 1 further comprising:
storing, in the database, new hire data; and
linking one or more elements of the new hire data to an employer position,
wherein the report resulting from the report profile further relates one or more elements of the new hire data for a plurality of new hires to one or more of the employer positions.

5. The method of claim 4 wherein the elements of the new hire data comprise data indicative of gender and ethnicity.

6. The method of claim 1 wherein an applicant request will be rejected unless at least one job is specified.

7. The method of claim 1 further comprising the step of displaying a list of available specified jobs prior to the first receiving step.

8. The method of claim 1 further comprising the step of providing a search engine whereby a user may search for available jobs prior to the first receiving step.

9. The method of claim 1 further comprising the step of providing a jobs agent that periodically searches a database of available jobs and notifies a user when a job meeting user-specified criteria is available.

10. A recruitment data management system, comprising:
an employer computing device having a memory and a processor; and
an employer database accessible by the employer computing device,
whereby the memory stores computer program instructions that instruct the employer computing device to perform the steps of:
receiving an applicant request for a specified job;
receiving applicant data comprising gender and ethnicity data;
storing the applicant data in the employer database;
linking one or more elements of the applicant data to an employer position; and
providing a report profile whereby a resulting report relates one or more elements of the applicant data for a plurality of applicants to one or more of the employer positions.

11. The system of claim 10 wherein the instructions further instruct the employer computing device to perform the steps of:
storing, in the database, new hire data comprising gender and ethnicity information; and
linking one or more elements of the new hire data to an employer position,
wherein the report resulting from the report profile further relates one or more elements of the new hire data for a plurality of new hires to one or more of the employer positions.

12. The method of claim 11 wherein the elements of the new hire data comprise data indicative of gender and ethnicity.

13. The system of claim 10 wherein each employer position comprises a specified job or a job group corresponding to one or more specified jobs.

14. The system of claim 10 wherein the elements of the applicant data comprise gender and ethnicity data.

15. The system of claim 10 wherein the instructions further instruct the employer computing device to reject an applicant request unless at least one job is specified.

16. The system of claim 10 wherein the instructions further instruct the employer computing device to display a list of available specified jobs prior to receiving the applicant data.

17. The system of claim 10 wherein the instructions further instruct a user computing device to display a list of available specified jobs prior to receiving the applicant data.

18. The method of claim 10 wherein the instructions further instruct the employer computing device to provide a search engine whereby a user may search for available jobs prior to submitting the applicant data.

19. The method of claim 10 wherein the instructions further instruct a user computing device to provide a search engine whereby a user may search for available jobs prior to submitting the applicant data.

20. The method of claim 10 wherein the instructions further instruct the employer computing device to provide a jobs agent that periodically searches a database of available jobs and notifies a user when a job meeting user-specified criteria is available.

21. A recruitment data management system, comprising:
means for receiving an applicant request for a specified job and prohibiting receipt of a request unless a job is specified;
means for receiving and storing applicant data that includes gender and ethnicity information; and
means for providing a report that relates one or more elements of the applicant data for a plurality of applicants to one or more of the employer positions.

22. A method of managing job applicant data, comprising:
receiving an applicant request for a specified job and prohibiting receipt of a request unless a job is specified;
receiving applicant data including gender and ethnicity information;
storing the applicant data in a database;
linking one or more elements of the applicant data to the specified job or a job group; and
providing a report profile whereby a resulting report relates one or more elements of the applicant data for a plurality of applicants to one or more specified jobs or job groups.

23. The method of claim 19 further comprising:
storing, in the database, new hire data comprising gender and ethnicity information; and
linking one or more elements of the new hire data to one of the specified jobs or job groups,
wherein the report resulting from the report profile further relates one or more elements of the new hire data for a plurality of new hires to one or more of the specified jobs or job groups.
